(19) United States
(12) Patent Application Publication
(10) Pub. No.: US 2005/0108337 A1
(43) Pub. Date: May 19, 2005

(54) System, method, and computer program product for filtering electronic mail

(75) Inventor: Richard Lorenz, Brunswick (AU)

Correspondence Address: DOCKET CLERK, DM/EDS, P.O. DRAWER 800889, DALLAS, TX, 75380, US

(73) Assignee: ELECTRONIC DATA SYSTEMS CORPORATION, Plano, TX (US)

(21) Appl. No.: 10/714,544

(22) Filed: Nov. 14, 2003

(51) Int. Cl. G06F 15/16

(52) U.S. Cl. 709/206

(57) ABSTRACT

A system, method, and computer program product for filtering electronic mail. In one case, unwanted email is blocked at the server by employing automated methods to verify that the email is from either a known sender or an actual human user.

### TECHNICAL FIELD OF THE INVENTION

The present invention is directed, in general, to electronic mail management.

### BACKGROUND OF THE INVENTION

Unsolicited commercial email (UCE), commonly known as “spam,” has become an increasingly great problem for virtually all users of electronic mail. “Spammers” send millions of emails every day to vast lists of email addresses, and users then receive dozens or even hundreds of daily “spam” emails, many containing offensive content. Because email is extremely inexpensive to send, even the smallest customer response can make the practice worthwhile to the spammer.

Most computer users are forced to read each email in turn before they can determine whether or not it is spam and can be deleted. Other users take advantage of spam-filtering systems that attempt to identify and eliminate spam using a rules-based lexical analysis. These systems have proven unsuccessful at completely eliminating spam.

There is, therefore, a need in the art for an improved system, process and computer program product for filtering electronic mail.

### SUMMARY OF THE INVENTION

Disclosed is a system, method, and computer program product for filtering electronic mail. According to one embodiment, unwanted email is blocked at the server by employing automated methods to verify that the email is from either a known sender or an actual human user.

The foregoing has outlined rather broadly the features and technical advantages of the present invention so that those skilled in the art may better understand the detailed description of the invention that follows. Additional features and advantages of the invention will be described hereinafter that form the subject of the claims of the invention. Those skilled in the art will appreciate that they may readily use the conception and the specific embodiment disclosed as a basis for modifying or designing other structures for carrying out the same purposes of the present invention. Those skilled in the art will also realize that such equivalent constructions do not depart from the spirit and scope of the invention in its broadest form.

Before undertaking the DETAILED DESCRIPTION OF THE INVENTION below, it may be advantageous to set forth definitions of certain words or phrases used throughout this patent document: the terms “include” and “comprise,” as well as derivatives thereof, mean inclusion without limitation; the term “or” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, whether such a device is implemented in hardware, firmware, software or some combination of at least two of the same. It should be noted that the functionality associated with any particular controller may be centralized or distributed, whether locally or remotely. Definitions for certain words and phrases are provided throughout this patent document, and those of ordinary skill in the art will understand that such definitions apply in many, if not most, instances to prior as well as future uses of such defined words and phrases.

### BRIEF DESCRIPTION OF THE DRAWINGS

For a more complete understanding of the present invention, and the advantages thereof, reference is now made to the following descriptions taken in conjunction with the accompanying drawings, wherein like numbers designate like objects, and in which:

FIG. 1 depicts a block diagram of a data processing system in which various embodiments of the present invention can be implemented;

FIG. 2 depicts a flowchart of a process in accordance with a preferred embodiment; and

FIG. 3 depicts an exemplary word that is obscured so as not to be easily machine-readable.

### DETAILED DESCRIPTION OF THE INVENTION

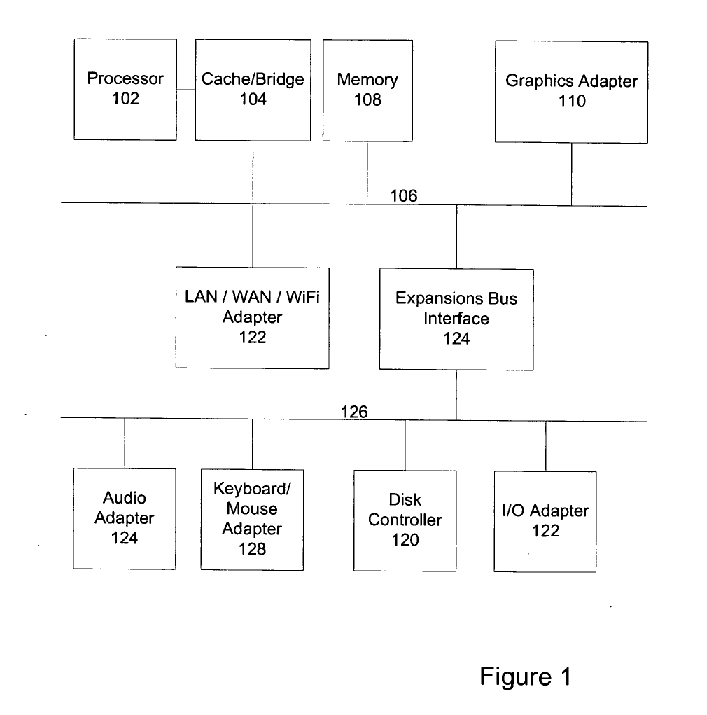

FIGS. 1 through 3, discussed below, and the various embodiments used to describe the principles of the present invention in this patent document are by way of illustration only and should not be construed in any way to limit the scope of the invention. Those skilled in the art will understand that the principles of the present invention may be implemented in any suitably arranged device. The numerous innovative teachings of the present application will be described with particular reference to the presently preferred embodiment.

FIG. 1 depicts a block diagram of a data processing system in which a preferred embodiment can be implemented, as either a client or server system. The data processing system depicted includes a processor 102 connected to a level two cache/bridge 104, which is connected in turn to a local system bus 106. Local system bus 106 may be, for example, a peripheral component interconnect (PCI) architecture bus. Also connected to local system bus in the depicted example are a main memory 108 and a graphics adapter 110.

Other peripherals, such as local area network (LAN)/Wide Area Network/Wireless (e.g. WiFi) adapter 112, may also be connected to local system bus 106. Expansion bus interface 114 connects local system bus 106 to input/output (I/O) bus 116. I/O bus 116 is connected to keyboard/mouse adapter 118, disk controller 120, and I/O adapter 122.

Also connected to I/O bus 116 in the example shown is audio adapter 124, to which speakers (not shown) may be connected for playing sounds. Keyboard/mouse adapter 118 provides a connection for a pointing device (not shown), such as a mouse, trackball, trackpointer, etc.

Those of ordinary skill in the art will appreciate that the hardware depicted in FIG. 1 may vary for particular. For example, other peripheral devices, such as an optical disk drive and the like, also may be used in addition or in place of the hardware depicted. The depicted example is provided for the purpose of explanation only and is not meant to imply architectural limitations with respect to the present invention.

A data processing system in accordance with a preferred embodiment of the present invention includes an operating system, optionally employing a graphical user interface. When a graphical user interface is employed, the operating system permits multiple display windows to be presented in the graphical user interface simultaneously, with each display window providing an interface to a different application or to a different instance of the same application. A cursor in the graphical user interface may be manipulated by a user through the pointing device. The position of the cursor may be changed and/or an event, such as clicking a mouse button, generated to actuate a desired response.

One of various commercial operating systems, such as Unix, Linux, or a version of Microsoft Windows™, a product of Microsoft Corporation located in Redmond, Wash. may be employed if suitably modified. The operating system is modified or created in accordance with the present invention as described.

One embodiment of the present invention uses an intro-word in the subject line of a received email as a keyword to verify that the sender is a valid sender and that all email from that sender should be delivered. Further, user-specified authorized addresses and domains are used to validate other email for delivery.

In addition, one embodiment provides a means for automatically responding to suspect email to allow a sender to verify that the email comes from a valid user who can communicate with the recipient.

In the preferred embodiment, the filtering is performed by the email recipient's mail server.

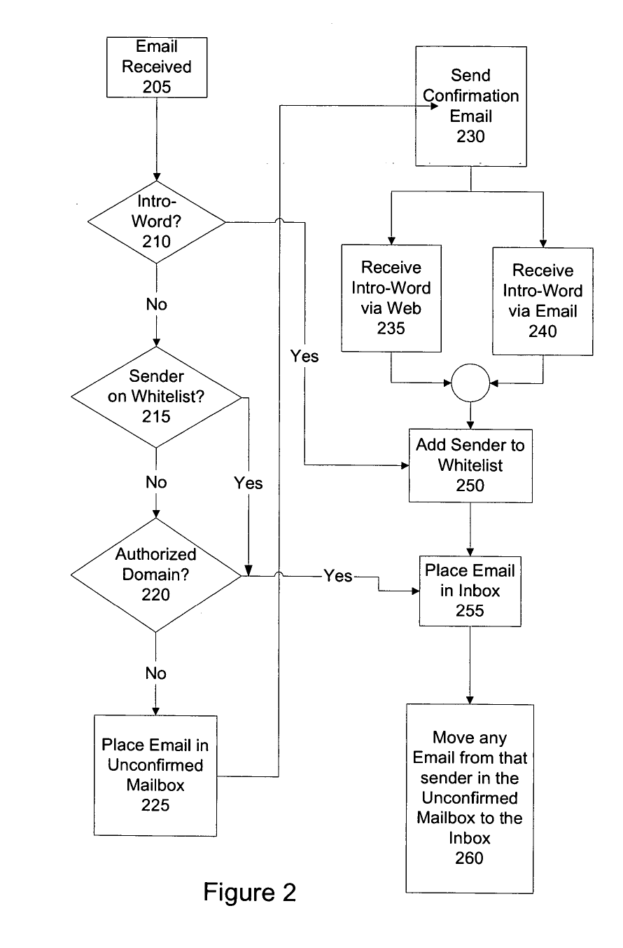

FIG. 2 depicts a flowchart of a process in accordance with a preferred embodiment.

First, an email is received by the recipient's mail server (step 205). The mail server then performs a series of checks on the email.

If the subject line includes that receiver's intro-word (step 210), then the sender's email address is added to the “white list” (step 250), which is a list of all valid senders, that message is accepted into the recipient's inbox (step 255), and any messages currently stored in the unconfirmed mailbox from that sender are delivered to the recipient's inbox (step 260).

If the message comes from anyone listed on the whitelist as an authorized sender (step 215), then that message is accepted into the recipient's inbox (step 255).

If that message comes from an authorized domain (e.g., any address at example.com) (step 220), then the message is accepted into the inbox (step 255).

If none of the previous conditions have been met, the message is placed in the unconfirmed mailbox (step 225).

For unconfirmed messages, an e-mail is sent back to the sender asking them to click on a link in order to confirm that the message was sent from a real person and not a spam computer (step 230). Following is an exemplary confirmation email:

Dear Sir/Madam,
***This is an automated response***
In order to eliminate Spam I reject all messages from people who
have not sent me e-mail before and that do not have my intro-word
(see below) in the subject. I have just received a message from
your e-mail address with the subject above. Your message has not
been deleted but to confirm that your e-mail is not Spam either
reply to this e-mail with my intro-word in the subject line or
click on the link below.
http://www.example.com?From=abc@def.ghi?To=xyz@tko.mno

Sincerely...
Note:
My intro-word is the second word in the next sentence. The convoluted way of describing my intro-word is to prevent Spam computers from harvesting it and subjecting me to unwanted Spam. If you would also like 100% guaranteed Spam protection click on: http://www.example.com/.

At this point, the sender can simply reply to the email, including the intro-word in the subject. When the response email including the intro-word is received (step 240), then the sender's email address is added to the “white list” (step 250), which is a list of all valid senders, that message is accepted into the recipient's inbox (step 255), and any messages currently stored in the unconfirmed mailbox from that sender are delivered to the recipient's inbox (step 260).

In a preferred embodiment, users of this system will be required to set a timeout period so that if a response is not received within a certain timeout period then the message will be deleted.

If the sender chooses to activate the Internet web link from the confirmation email, the server system will receive the request, and transmit to the sender a confirmation word or code and a request that the sender respond by typing in that word or code.

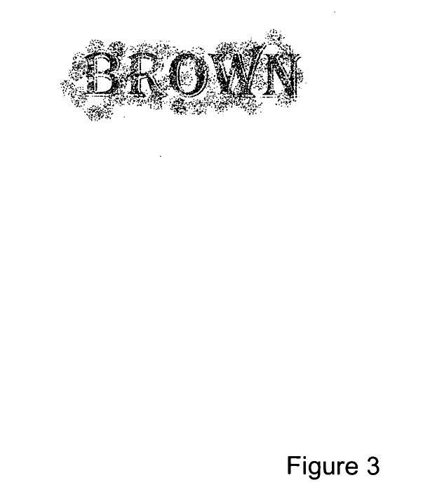

Preferably, the word or code transmitted to the user is in a non-computer harvestable form. This can be accomplished as in the exemplary note above, where the word is simply chosen from others on the screen, and the text of the message instructs the sender on how to locate the word. Alternately, the word can be transmitted and displayed as an image that has been manipulated to discourage optical character recognition. FIG. 3 shows an exemplary word manipulated in such a fashion; while it is easy for a person to read, it is not in a form that a computer system can readily decipher.

If the intro word is typed in correctly via the web page (step 235), then the sender's email address is added to the “white list” (step 250), which is a list of all valid senders, that message is accepted into the recipient's inbox (step 255), and any messages currently stored in the unconfirmed mailbox from that sender are delivered to the recipient's inbox (step 260).

If none of the above conditions have been met, including if the correct word was not received (in steps 235 or 240), the email is presumed to be spam and is left in the unconfirmed mailbox for a predefined period of time, then is typically deleted.

This process therefore provides a means that will effectively eliminate 100% of received spam before it is delivered to the recipient. Indeed, preferably the spam is never seen by the recipient at all.

One particular feature of at least some disclosed embodiment involves getting confirmation that senders unknown to the receiver are real people and is performed by getting the person to type in or send a special word. As described above, this word will be given to the sender in a form unreadable to computers. One way of doing so is by using descriptive text such as: “My intro-word is the third word in the following sentence. The quick brown fox . . . .” Another approach is transmitting the word as an obscured image, as described above.

Preferably, all of the processing above is performed on the recipient's email server—generally a server owned by the internet service provider supplying their e-mail service. In alternate embodiments, some or all received e-mail can be downloaded to the client data processing system to perform the processing described herein. Also, according to other embodiments, the “unconfirmed” mailbox is on a different mail server than the recipient's local email store. Further, according to some embodiments, the server system that handles the confirmation response and web interface is a different system than the recipient's mail server.

In some embodiments, the intro-word, or multiple intro-words, are user selectable to ensure that specific types of emails, such as mailing-list messages, are received into the inbox.

Another feature of some embodiments includes a web site that allows access to all e-mails that are unconfirmed. After registering for a mailserver, the user can check all unconfirmed e-mails and add any senders to the valid senders list.

Those skilled in the art will recognize that, for simplicity and clarity, the full structure and operation of all data processing systems suitable for use with the present invention is not being depicted or described herein. Instead, only so much of a data processing system as is unique to the present invention or necessary for an understanding of the present invention is depicted and described. The remainder of the construction and operation of data processing system 100 may conform to any of the various current implementations and practices known in the art.

It is important to note that while the present invention has been described in the context of a fully functional system, those skilled in the art will appreciate that at least portions of the mechanism of the present invention are capable of being distributed in the form of instructions contained within a machine usable medium in any of a variety of forms, and that the present invention applies equally regardless of the particular type of instruction or signal bearing medium utilized to actually carry out the distribution. Examples of machine usable mediums include: nonvolatile, hard-coded type mediums such as read only memories (ROMs) or erasable, electrically programmable read only memories (EEPROMs), user-recordable type mediums such as floppy disks, hard disk drives and compact disk read only memories (CD-ROMs) or digital versatile disks (DVDs), and transmission type mediums such as digital and analog communication links.

Although an exemplary embodiment of the present invention has been described in detail, those skilled in the art will understand that various changes, substitutions, variations, and improvements of the invention disclosed herein may be made without departing from the spirit and scope of the invention in its broadest form.

None of the description in the present application should be read as implying that any particular element, step, or function is an essential element which must be included in the claim scope: THE SCOPE OF PATENTED SUBJECT MATTER IS DEFINED ONLY BY THE ALLOWED CLAIMS. Moreover, none of these claims are intended to invoke paragraph six of 35 USC §112 unless the exact words “means for” are followed by a participle.

1. A method for filtering electronic mail, comprising:
receiving, in a data processing system, an electronic mail message;
determining if the electronic mail message includes an intro-word;
delivering the electronic mail message if the electronic mail message includes the intro-word; and
storing the electronic mail message if the electronic mail message does not include the intro-word.

2. The method of claim 1, wherein the intro-word is located in a subject line of the electronic mail message.

3. The method of claim 1, further comprising delivering the electronic mail message if the email address of a sender of the electronic mail message is on an authorized sender list.

4. The method of claim 1, further comprising delivering the electronic mail message if the domain name of a sender of the electronic mail message is on an authorized domain list.

5. The method of claim 1, further comprising, if the electronic mail message does not include the intro-word, then sending a confirmation message to the sender of the electronic mail message.

6. The method of claim 5, further comprising:
receiving a response mail message corresponding to the confirmation message;
delivering the electronic mail message if the response mail message includes the intro-word; and
storing the electronic mail message if the response mail message does not include the intro-word.

7. The method of claim 5, further comprising:
receiving a response corresponding to the confirmation message via an internet connection;
delivering the electronic mail message if the response includes the intro-word; and
storing the electronic mail message if the response does not include the intro-word.

8. The method of claim 5, further comprising sending an obscured image of the intro-word to the sender.

9. The method of claim 5, further comprising sending the intro-word to the sender in a non-machine-readable form.

10. The method of claim 1, further comprising deleting the stored electronic mail message after a predetermined amount of time.

11. A data processing system having at least a processor and accessible memory, comprising:
means for receiving, in the data processing system, an electronic mail message;
means for determining if the electronic mail message includes an intro-word;
means for delivering the electronic mail message if the electronic mail message includes the intro-word; and
means for storing the electronic mail message if the electronic mail message does not include the intro-word.

12. The data processing system of claim 11, wherein the intro-word is located in a subject line of the electronic mail message.

13. The data processing system of claim 11, further means for comprising delivering the electronic mail message if the email address of a sender of the electronic mail message is on an authorized sender list.

14. The data processing system of claim 11, further comprising means for delivering the electronic mail message if the domain name of a sender of the electronic mail message is on an authorized domain list.

15. The data processing system of claim 11, further comprising means for sending a confirmation message to the sender of the electronic mail message if the electronic mail message does not include the intro-word.

16. The data processing system of claim 15, further comprising:
means for receiving a response mail message corresponding to the confirmation message;
means for delivering the electronic mail message if the response mail message includes the intro-word; and
means for storing the electronic mail message if the response mail message does not include the intro-word.

17. The data processing system of claim 15, further comprising:
means for receiving a response corresponding to the confirmation message via an internet connection;
means for delivering the electronic mail message if the response includes the intro-word; and
means for storing the electronic mail message if the response does not include the intro-word.

18. The data processing system of claim 15, further comprising means for sending an obscured image of the intro-word to the sender.

19. The data processing system of claim 15, further comprising means for sending the intro-word to the sender in a non-machine-readable form.

20. The data processing system of claim 11, further comprising means for deleting the stored electronic mail message after a predetermined amount of time.

21. A computer program product tangibly embodied in a machine-readable medium, comprising:
instructions for receiving, in a data processing system, an electronic mail message;
instructions for determining if the electronic mail message includes an intro-word;
instructions for delivering the electronic mail message if the electronic mail message includes the intro-word; and
instructions for storing the electronic mail message if the electronic mail message does not include the intro-word.

22. The computer program product of claim 21, wherein the intro-word is located in a subject line of the electronic mail message.

23. The computer program product of claim 21, further comprising instructions for delivering the electronic mail message if the email address of a sender of the electronic mail message is on an authorized sender list.

24. The computer program product of claim 21, further comprising instructions for delivering the electronic mail message if the domain name of a sender of the electronic mail message is on an authorized domain list.

25. The computer program product of claim 21, further comprising instructions for sending a confirmation message to the sender of the electronic mail message if the electronic mail message does not include the intro-word.

26. The computer program product of claim 25, further comprising:
instructions for receiving a response mail message corresponding to the confirmation message;
instructions for delivering the electronic mail message if the response mail message includes the intro-word; and
instructions for storing the electronic mail message if the response mail message does not include the intro-word.

27. The computer program product of claim 25, further comprising:
instructions for receiving a response corresponding to the confirmation message via an internet connection;
instructions for delivering the electronic mail message if the response includes the intro-word; and
instructions for storing the electronic mail message if the response does not include the intro-word.

28. The computer program product of claim 25, further comprising instructions for sending an obscured image of the intro-word to the sender.

29. The computer program product of claim 25, further comprising instructions for sending the intro-word to the sender in a non-machine-readable form.

30. The computer program product of claim 21, further comprising instructions for deleting the stored electronic mail message after a predetermined amount of time.
